(19) United States
(12) Patent Application Publication
(10) Pub. No.: US 2024/0403432 A1
(43) Pub. Date: Dec. 5, 2024

(54) SECURE APPLICATION BRING-UP WITH HASH CREATION DURING SECURE DOWNLOAD APPARATUS AND METHOD

(71) Applicant: Altiostar Networks India Private Limited, Bangalore, KARNATAKA (IN)

(72) Inventors: Arun MENON, Bangalore (IN); Satish BALAGOPALAN, Bangalore (IN); Raghul RAVIRAJH, Bangalore (IN)

(21) Appl. No.: 18/259,395

(22) PCT Filed: Jan. 31, 2023
(86) PCT No.: PCT/US2023/011987

§ 371 Date: Jun. 27, 2023

(51) Int. Cl. G06F 21/57; G06F 21/64

(52) U.S. Cl. CPC G06F 21/572; G06F 21/64

(57) ABSTRACT

An apparatus executes firmware to verify a bootloader. The verified bootloader is caused to be executed to verify a kernel. In response to verifying the kernel, the kernel is caused to be executed to verify a trust agent. In response to verifying the trust agent, the trust agent is caused to process an application list to identify one or more files that are part of an application and to generate a hash for all of the one or more files combined or for each of the one or more files individually. The apparatus also compares the hash for all of the one or more files combined or for each of the one or more files individually with a hash included in an application manifest file and, in response to confirming a hash match, causes the one or more files that are part of the application to be executed.

### TECHNICAL FIELD

The present disclosure is related to secure application bring-up with hash creation during secure download.

### BACKGROUND

Booting is a process of loading system software into a main memory of a computer system. A booting process begins with the execution of hardware/firmware that performs a power-on self-test and is followed by loading and execution of a bootloader. Some computer systems implement the UEFI (Unified Extensible Firmware Interface) standard. In computer systems that implement the UEFI standard, “secure” booting may be enabled. Security measures for a secure boot cycle in UEFI often include ensuring that the firmware and lower-level boot components are verified during every boot cycle.

### SUMMARY

An aspect of this description is related to an apparatus for secure application bring-up with hash creation during secure download. The apparatus comprises a processor and a memory having instructions stored thereon that, when executed by the processor, cause the apparatus to cause firmware executed by a processor to verify a bootloader. The apparatus is also caused to, in response to verifying the bootloader, cause the bootloader to be executed to verify a kernel. The apparatus is also caused to, in response to verifying the kernel, cause the kernel to be executed to verify a trust agent. The apparatus is also caused to, in response to verifying the trust agent, cause the trust agent to process an application list to identify one or more files that are part of an application and to generate a hash for all of the one or more files combined or for each of the one or more files individually. The apparatus is also caused to compare the hash for all of the one or more files combined or for each of the one or more files individually with a hash included in an application manifest file stored in a secure storage. The apparatus is also caused to, in response to confirming a hash match between the hash for all of the one or more files combined or for each of the one or more files individually and the hash included in the application manifest file, cause the one or more files that are part of the application to be executed.

Another aspect of this description is related a method for secure application bring-up with hash creation during secure download. The method comprises causing firmware executed by a processor to verify a bootloader. The method also comprises, in response to verifying the bootloader, causing the bootloader to be executed to verify a kernel. The method also comprises, in response to verifying the kernel, causing the kernel to be executed to verify a trust agent. The method also comprises, in response to verifying the trust agent, causing the trust agent to process an application list to identify one or more files that are part of an application and to generate a hash for all of the one or more files combined or for each of the one or more files individually. The method also comprises comparing the hash for all of the one or more files combined or for each of the one or more files individually with a hash included in an application manifest file stored in a secure storage. The method also comprises, in response to confirming a hash match between the hash for all of the one or more files combined or for each of the one or more files individually and the hash included in the application manifest file, causing the one or more files that are part of the application to be executed.

Another aspect of this description is related to a non-transitory computer readable for secure application bring-up with hash creation during secure download. The non-transitory computer readable medium has instructions stored thereon that, when executed by a processor, cause an apparatus to cause firmware executed by a processor to verify a bootloader. The apparatus is also caused to, in response to verifying the bootloader, cause the bootloader to be executed to verify a kernel. The apparatus is also caused to, in response to verifying the kernel, cause the kernel to be executed to verify a trust agent. The apparatus is also caused to, in response to verifying the trust agent, cause the trust agent to process an application list to identify one or more files that are part of an application and to generate a hash for all of the one or more files combined or for each of the one or more files individually. The apparatus is also caused to compare the hash for all of the one or more files combined or for each of the one or more files individually with a hash included in an application manifest file stored in a secure storage. The apparatus is also caused to, in response to confirming a hash match between the hash for all of the one or more files combined or for each of the one or more files individually and the hash included in the application manifest file, cause the one or more files that are part of the application to be executed.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a computer system for secure application bring-up with hash creation during secure download, in accordance with one or more embodiments.

FIG. 2 is a diagram of a process for hash creation during secure download, in accordance with one or more embodiments.

FIG. 3 is a flowchart of a process for secure application bring-up with hash creation during secure download, in accordance with one or more embodiments.

FIG. 4 is a functional block diagram of a computer or processor-based system upon which or by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Booting is a process of loading system software into a main memory of a computer. The booting process is triggered by, for example, powering on the computer system or by a soft restart that does not require power cycling of the computer system. The booting process begins with the execution of hardware/firmware that performs a power-on self-test and is followed by loading and execution of a bootloader.

Computer systems that implement the UEFI (Unified Extensible Firmware Interface) standard often enable “secure” booting. For secure booting, the UEFI firmware checks that the bootloader is signed with a designated cryptographic key.

Security measures for a secure boot cycle in UEFI often include ensuring that the firmware and lower-level boot components are verified during every boot cycle. There are many ways of achieving secure boot either by verifying every boot component before it is executed or by taking measurements of each component before execution and getting these measurements attested by an external entity.

In some systems, hardware/firmware verifies a shim, passes control to the shim and executes it. The shim verifies a grub, passes control to the grub, and executes it. The grub verifies an operating system kernel and loads the same. The bootloader, for example, comprises the shim and grub. The operating system kernel then verifies kernel modules and loads the same.

Conventional systems only verify the boot components up to and including the operating system. Applications instantiated after successful operating system bring-up, however, are not verified.

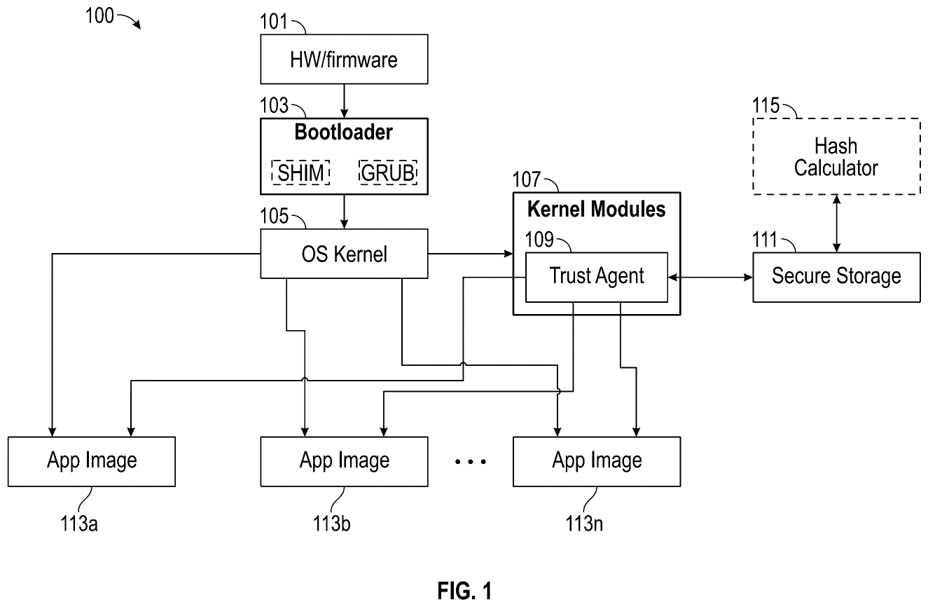

FIG. 1 is a diagram of a computer system 100 for secure application bring-up with hash creation during secure download, in accordance with one or more embodiments. Computer system 100 provides a mechanism to verify the components in a computer system during the boot cycle by facilitating secure application bring-up with hash creation during secure download.

Computer system 100 is configured to use the root of trust in accordance with the UEFI secure boot mechanism to provide a trust anchor. In some embodiments, computer system 100 improves system security by providing verification of all components in the system, including applications, every boot cycle while simplifying the secure boot of application by leveraging the root of trust mechanism for a secure boot in accordance with UEFI.

Computer system 100 comprises hardware/firmware 101, bootloader 103, operating system kernel 105, kernel modules 107, trust agent 109 and secure storage 111. Application images 113a-113n (collectively referred to as application image 113) are one or more files that are a part of an application to be executed by computer system 100. In some embodiments, computer system 100 includes a hash calculator 115. In some embodiments, hash calculator 115 is external to computer system 100.

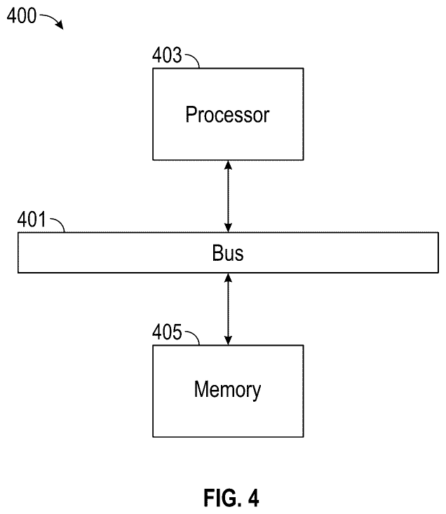

In some embodiments, one or more of hardware/firmware 101, bootloader 103, operating system kernel 105, kernel modules 107, trust agent 109, secure storage 111, application images 113, and hash calculator 115 comprises a set of computer readable instructions that are stored in a memory such as memory 405 (FIG. 4) and that, when executed by a processor such as a processor 403 (FIG. 4), causes computer system 100 to perform the processes discussed in accordance with one or more embodiments.

In some embodiments, secure storage 111 is a memory such as a memory 405 capable of being queried or caused to store data in accordance with one or more embodiments.

In a secure booting process implemented by computer system 100, hardware/firmware 101 is executed to verify bootloader 103. In response to verifying bootloader 103, bootloader 103 is executed to verify operating system kernel 105. In response to verifying operating system kernel 105, operating system kernel 105 is executed to verify trust agent 109.

Trust agent 109 processes an application list to identify one or more files that are part of an application and to generate a hash for all of the one or more files combined or for each of the one or more files individually. In some embodiments, in response to being verified, trust agent 109 processes an application list to identify the one or more files that are part of the application included in the application package and to generate the hash for the one or more files included in the application package. In some embodiments, the application list is stored in secure storage 111. In some embodiments, the application list is stored in a different memory associated with computer system 100 such as a storage location of the one or more application images 113, a storage location of an application package comprising the one or more application images 113, or some other suitable location.

In response to receiving an application package comprising the one or more files that are part of the application during a secure download of the one or more files that are part of the application to computer 100, hash calculator 115 is caused to calculate a hash for the application package and to generate an application manifest file comprising the hash for the application package. In some embodiments, hash calculator 115 is a component of computer system 100 that is executed by a processor such as processor 403 or some other processor associated with computer system 100. In some embodiments, hash calculator 115 is external to computer system 100 and hash calculator 115 calculates the hash for the application package and causes the application manifest file to be downloaded with the application package for secure download to computer 100. The application manifest file is stored in secure storage 111. In some embodiments, the application manifest file is generated before the hardware/firmware 101) is executed. In some embodiments, the application manifest file is generated after the hardware/firmware 101 is executed and before the trust agent 109 is executed.

Trust agent 109 compares the hash for all of the one or more files combined, for each of the one or more files individually, and/or for the application package with the hash included in the application manifest file stored in secure storage 111.

In response to confirming a hash match between the hash for all of the one or more files combined, for each of the one or more files individually, and/or for the application package and the hash included in the application manifest file, computer system 100 causes the one or more files that are part of the application to be executed.

In some embodiments, trust agent 109 is a kernel module 107 among one or more other kernel modules 107 that operating system kernel 105 verifies and executes. In some embodiments, bootloader 103 comprises a shim and a grub. Hardware/firmware 101 verifies the shim to verify bootloader 103, and causes the shim to be executed to verify the grub. Then, in response to verifying the grub, the grub verifies operating system kernel 105 such that bootloader 103 verifies the operating system kernel 105.

In some embodiments, trust agent 109 calculates the hash for all of the one or more files combined, and the hash for the application package is applicable for all of the one or more files. In some embodiments, trust agent 109 is caused to calculate the hash for each of the one or more files individually, and the hash for the application package is applicable for all of the one or more files.

In some embodiments, hash calculator 115 is caused to calculate the hash for each of the one or more files included in the application package individually for inclusion in the application manifest file as the hash for the application package, trust agent 109 is caused to calculate the hash for each of the one or more files individually, and the hash match is determined based on a one-to-one matching of between the hash for each corresponding file of the one or more files included in the application package calculated by hash calculator 115 included in the application manifest file and the hash for each corresponding file of the one or more files included in the application package calculated by trust agent 109.

In some embodiments, the application manifest file generated by hash calculator 115 for inclusion with the application package is signed by a signing module such that the application manifest file is secured with the application package and the application manifest file is capable of being confirmed as being associated with a trusted source.

In some embodiments, in response to confirming the application manifest file is associated with a trusted source, the application manifest file is caused to be stored in secure storage 111.

According to various embodiments, computer system 100 verifies the boot components up to and including the operating system, and applications instantiated after successful operating system bring-up. Computer system 100 provides a mechanism to verify the components in a computer system during the boot cycle by facilitating secure application bring-up with hash creation during secure download. Computer system 100 uses the root of trust in accordance with the UEFI secure boot mechanism to provide a trust anchor and generate a hash with the application that is used to verify in the root of trust to bring-up applications securely. Computer system 100 improves system security by providing verification of all components in the system, including applications, every boot cycle while simplifying the secure boot of application by leveraging the root of trust mechanism for secure boot in accordance with UEFI.

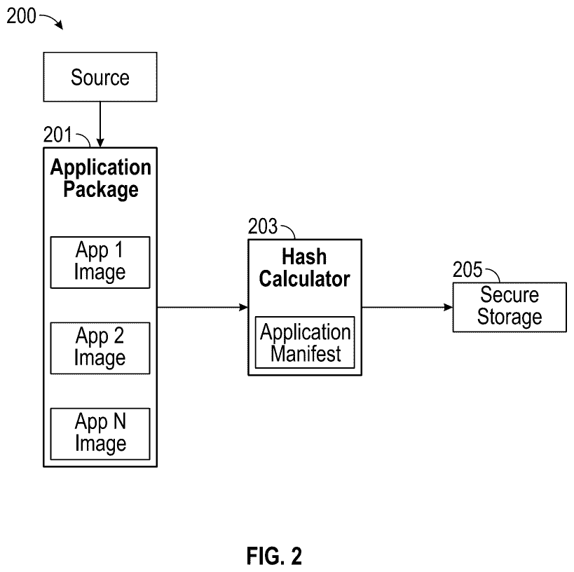

FIG. 2 is a block diagram of a process 200 for hash creation during secure download, in accordance with one or more embodiments. In some embodiments, process 200 is performed by hash calculator 115 (FIG. 1) included in computer system 100 (FIG. 1). In some embodiments, process 200 is performed by a hash calculator 115 that is external to computer system 100 and in communication with computer system 100.

In step 201, one or more files that are part of an application are downloaded as an application package from a source.

In step 203, hash calculator 115 calculates a hash for the application package and generates the application manifest file comprising the hash for application package. In some embodiments the application manifest file is added to application package. In some embodiments, the application manifest file is generated before the hardware/firmware 101 (FIG. 1) is executed. In some embodiments, the application manifest file is generated after the hardware/firmware 101 is executed and before the trust agent 109 is executed.

In some embodiments, hash calculator 115 calculates the hash for each of the one or more application images included in the application package individually for inclusion in the application manifest file as the hash for application package, trust agent 109 (FIG. 1) calculates the hash for each of the one or more application images included in the application package, and the hash match is determined based on a one-to-one matching of between the hash for each corresponding application image of the one or more application images included in the application package calculated by the hash calculator 115 that is included in the application manifest file and the hash for each corresponding application image of the one or more application images included in application package calculated by trust agent 109.

In some embodiments, the application manifest file included in application package is signed by a signing module such that the application manifest file is secured with the application package and the application manifest file is capable of being confirmed as being associated with a trusted source.

In step 205, the application manifest file is stored in secure storage 111 (FIG. 1). In some embodiments, in response to confirming the application manifest file is associated with a trusted source, the application manifest file is caused to be stored in the secure storage 111.

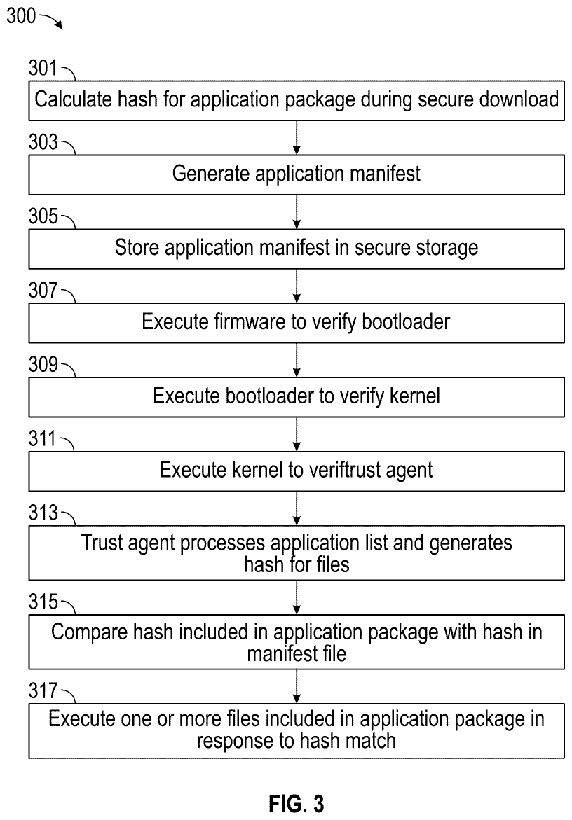

FIG. 3 is a flowchart of a process 300 of secure application bring-up with hash creation during secure download, in accordance with one or more embodiments. In some embodiments, process 300 is performed by computer system 100 (FIG. 1) including a hash calculator 115 (FIG. 1). In some embodiments, process 300 is performed by computer system 100 in combination with a hash calculator 115 that is external to computer system 100 and in communication with computer system 100.

In step 301, during a secure download of one or more files that are part of an application from a source, hash calculator 115 is caused to calculate a hash for an application package comprising the one or more files that are part of the application. In some embodiments, in response to receiving the one or more files that are part of the application by way of a secure download from a source, the one or more files that are part of the application are packaged to create an application package, and the hash calculator is caused to calculate the hash for the application package.

In step 303, an application manifest file is caused to be generated, including the hash calculated for the application package.

In step 305, the application manifest file is caused to be stored in a secure storage.

In step 307, hardware/firmware is executed to verify a bootloader. In some embodiments, the bootloader comprises a shim and a grub, the hardware/firmware verifies the shim to verify the bootloader and causes the shim to be executed to verify the grub, and, in response to verifying the grub, the grub verifies the operating system kernel such that the bootloader verifies the operating system kernel.

In some embodiments, the application manifest file is generated before hardware/firmware is executed in step 307. In some embodiments, the application manifest file is generated after the hardware/firmware is executed in step 307.

In step 309, in response to verifying the bootloader, the bootloader is caused to be executed to verify the operating system kernel.

In step 311, in response to verifying the operating system kernel, the operating system kernel is caused to be executed to verify a trust agent. In some embodiments, the trust agent is a kernel module. In some embodiments, the application manifest file is generated after the hardware/firmware is executed in step 307 and before the trust agent is executed in step 311.

In step 313, in response to verifying the trust agent, the trust agent is caused to process an application list to identify the one or more files that are part of the application and to generate a hash for all of the one or more files combined or for each of the one or more files individually. In some embodiments, the trust agent is caused to calculate the hash for all of the one or more files combined, and the hash for the application package is applicable for all of the one or more files. In some embodiments, the trust agent is caused to calculate the hash for each of the one or more files individually, and the hash for the application package is applicable for all of the one or more files.

In step 315, the hash for all of the one or more files combined or for each of the one or more files individually is compared with the hash included in an application manifest file.

In step 317, in response to confirming a hash match between the hash for all of the one or more files combined or for each of the one or more files individually and the hash included in the application manifest file, the one or more files that are part of the application are caused to be executed.

FIG. 4 is a functional block diagram of a computer or processor-based system 400 upon which or by which an embodiment is implemented.

Processor-based system 400 is programmed to facilitate secure application bring-up with hash creation during secure download, as described herein, and includes, for example, bus 401, processor 403, and memory 405 components.

In some embodiments, the processor-based system is implemented as a single “system on a chip.” Processor-based system 400, or a portion thereof, constitutes a mechanism for performing one or more steps of secure application bring-up with hash creation during secure download.

In some embodiments, the processor-based system 400 includes a communication mechanism such as bus 401 for transferring and/or receiving information and/or instructions among the components of the processor-based system 400. Processor 403 is connected to the bus 401 to obtain instructions for execution and process information stored in, for example, the memory 405. In some embodiments, the processor 403 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 403. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 403 performs a set of operations on information as specified by a set of instructions stored in memory 405 related to secure application bring-up with hash creation during secure download. The execution of the instructions causes the processor to perform specified functions.

The processor 403 and accompanying components are connected to the memory 405 via the bus 401. The memory 405 includes one or more of dynamic memory (e.g., RAM, magnetic disk, writable optical disk, etc.) and static memory (e.g., ROM, CD-ROM, etc.) for storing executable instructions that when executed perform the steps described herein to facilitate secure application bring-up with hash creation during secure download. The memory 405 also stores the data associated with or generated by the execution of the steps.

In one or more embodiments, the memory 405, such as a random-access memory (RAM) or any other dynamic storage device, stores information including processor instructions for secure application bring-up with hash creation during secure download. Dynamic memory allows information stored therein to be changed. RAM allows a unit of information stored at a location called a memory address to be stored and retrieved independently of information at neighboring addresses. The memory 405 is also used by the processor 403 to store temporary values during execution of processor instructions. In various embodiments, the memory 405 is a read only memory (ROM) or any other static storage device coupled to the bus 401 for storing static information, including instructions, that is not capable of being changed by processor 403. Some memory is composed of volatile storage that loses the information stored thereon when power is lost. In some embodiments, the memory 405 is a non-volatile (persistent) storage device, such as a magnetic disk, optical disk, or flash card, for storing information, including instructions, that persists even when the system 400 is turned off or otherwise loses power.

The term “computer-readable medium” as used herein refers to any medium that participates in providing information to processor 403, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to an apparatus for secure application bring-up with hash creation during secure download. The apparatus comprises a processor and a memory having instructions stored thereon that, when executed by the processor, cause the apparatus to cause firmware executed by a processor to verify a bootloader. The apparatus is also caused to, in response to verifying the bootloader, cause the bootloader to be executed to verify a kernel. The apparatus is also caused to, in response to verifying the kernel, cause the kernel to be executed to verify a trust agent. The apparatus is also caused to, in response to verifying the trust agent, cause the trust agent to process an application list to identify one or more files that are part of an application and to generate a hash for all of the one or more files combined or for each of the one or more files individually. The apparatus is also caused to compare the hash for all of the one or more files combined or for each of the one or more files individually with a hash included in an application manifest file stored in a secure storage. The apparatus is also caused to, in response to confirming a hash match between the hash for all of the one or more files combined or for each of the one or more files individually and the hash included in the application manifest file, cause the one or more files that are part of the application to be executed.

In some embodiments, the trust agent is a kernel module.

In some embodiments, the bootloader comprises a shim and a grub, the firmware verifies the shim to verify the bootloader and causes the shim to be executed to verify the grub, and in response to verifying the grub, the grub verifies the kernel such that the bootloader verifies the kernel.

In some embodiments, the apparatus is also caused to, in response to receiving an application package comprising the one or more files that are part of the application by way of a secure download from a source, cause a hash calculator to calculate a hash for the application package; generate the application manifest file, wherein the hash included in the application manifest file is the hash for the application package; and cause the application manifest file to be stored in the secure storage.

In some embodiments, the application manifest file is generated before the firmware is executed. In some embodiments, the application manifest file is generated after the firmware is executed and before the trust agent is executed.

In some embodiments, the apparatus is also caused to, during a secure download of the one or more files that are part of the application by way of a secure download from a source, cause a hash calculator to calculate a hash for an application package comprising the one or more files that are part of the application; generate the application manifest file, wherein the hash included in the application manifest file is the hash for the application package; and cause the application manifest file to be stored in the secure storage.

Another aspect of this description is related a method for secure application bring-up with hash creation during secure download. The method comprises causing firmware executed by a processor to verify a bootloader. The method also comprises, in response to verifying the bootloader, causing the bootloader to be executed to verify a kernel. The method also comprises, in response to verifying the kernel, causing the kernel to be executed to verify a trust agent. The method also comprises, in response to verifying the trust agent, causing the trust agent to process an application list to identify one or more files that are part of an application and to generate a hash for all of the one or more files combined or for each of the one or more files individually. The method also comprises comparing the hash for all of the one or more files combined or for each of the one or more files individually with a hash included in an application manifest file stored in a secure storage. The method also comprises, in response to confirming a hash match between the hash for all of the one or more files combined or for each of the one or more files individually and the hash included in the application manifest file, causing the one or more files that are part of the application to be executed.

In some embodiments, the trust agent is a kernel module.

In some embodiments, the bootloader comprises a shim and a grub, the firmware verifies the shim to verify the bootloader and causes the shim to be executed to verify the grub, and in response to verifying the grub, the grub verifies the kernel such that the bootloader verifies the kernel.

In some embodiments, the method also includes, in response to receiving an application package comprising the one or more files that are part of the application by way of a secure download from a source, causing a hash calculator to calculate a hash for the application package; generating the application manifest file, wherein the hash included in the application manifest file is the hash for the application package; and causing the application manifest file to be stored in the secure storage.

In some embodiments, the application manifest file is generated before the firmware is executed. In some embodiments, the application manifest file is generated after the firmware is executed and before the trust agent is executed.

In some embodiments, the method also includes, during a secure download of the one or more files that are part of the application by way of a secure download from a source, causing a hash calculator to calculate a hash for an application package comprising the one or more files that are part of the application; generating the application manifest file, wherein the hash included in the application manifest file is the hash for the application package; and causing the application manifest file to be stored in the secure storage.

Another aspect of this description is related to a non-transitory computer readable for secure application bring-up with hash creation during secure download. The non-transitory computer readable medium has instructions stored thereon that, when executed by a processor, cause an apparatus to cause firmware executed by a processor to verify a bootloader. The apparatus is also caused to, in response to verifying the bootloader, cause the bootloader to be executed to verify a kernel. The apparatus is also caused to, in response to verifying the kernel, cause the kernel to be executed to verify a trust agent. The apparatus is also caused to, in response to verifying the trust agent, cause the trust agent to process an application list to identify one or more files that are part of an application and to generate a hash for all of the one or more files combined or for each of the one or more files individually. The apparatus is also caused to compare the hash for all of the one or more files combined or for each of the one or more files individually with a hash included in an application manifest file stored in a secure storage. The apparatus is also caused to, in response to confirming a hash match between the hash for all of the one or more files combined or for each of the one or more files individually and the hash included in the application manifest file, cause the one or more files that are part of the application to be executed.

In some embodiments, the trust agent is a kernel module.

In some embodiments, the bootloader comprises a shim and a grub, the firmware verifies the shim to verify the bootloader and causes the shim to be executed to verify the grub, and in response to verifying the grub, the grub verifies the kernel such that the bootloader verifies the kernel.

In some embodiments, the apparatus is also caused to, in response to receiving an application package comprising the one or more files that are part of the application by way of a secure download from a source, cause a hash calculator to calculate a hash for the application package; generate the application manifest file, wherein the hash included in the application manifest file is the hash for the application package; and cause the application manifest file to be stored in the secure storage.

In some embodiments, the application manifest file is generated before the firmware is executed. In some embodiments, the application manifest file is generated after the firmware is executed and before the trust agent is executed.

In some embodiments, the apparatus is also caused to, during a secure download of the one or more files that are part of the application by way of a secure download from a source, cause a hash calculator to calculate a hash for an application package comprising the one or more files that are part of the application; generate the application manifest file, wherein the hash included in the application manifest file is the hash for the application package; and cause the application manifest file to be stored in the secure storage.

The foregoing outlines features of several embodiments so that those skilled in the art may better understand the aspects of the present disclosure. The present disclosure includes features that make it possible to verify boot components up to and including the operating system, and applications instantiated after successful operating system bring-up. The present disclosure provides a mechanism to verify the components in a computer system during the boot cycle by facilitating secure application bring-up with hash creation during secure download. The features discussed in the present disclosure use the root of trust in accordance with the UEFI secure boot mechanism to provide a trust anchor and generate a hash with the application that is used to verify in the root of trust to bring-up applications securely. The features discussed in the present disclosure improve computer system security by providing verification of all components in the system, including applications, every boot cycle while simplifying the secure boot of application by leveraging the root of trust mechanism for secure boot in accordance with UEFI.

Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An apparatus, comprising:
a processor; and
a memory having instructions stored thereon that, when executed by the processor, cause the apparatus to:
cause firmware executed by a processor to verify a bootloader;
in response to verifying the bootloader, cause the bootloader to be executed to verify a kernel;
in response to verifying the kernel, cause the kernel to be executed to verify a trust agent;
in response to verifying the trust agent, cause the trust agent to process an application list to identify one or more files that are part of an application and to generate a hash for all of the one or more files combined or for each of the one or more files individually;
compare the hash for all of the one or more files combined or for each of the one or more files individually with a hash included in an application manifest file stored in a secure storage; and
in response to confirming a hash match between the hash for all of the one or more files combined or for each of the one or more files individually and the hash included in the application manifest file, cause the one or more files that are part of the application to be executed.

2. The apparatus of claim 1, wherein the trust agent is a kernel module.

3. The apparatus of claim 1, wherein
the bootloader comprises a shim and a grub,
the firmware verifies the shim to verify the bootloader and causes the shim to be executed to verify the grub, and
in response to verifying the grub, the grub verifies the kernel such that the bootloader verifies the kernel.

4. The apparatus of claim 1, wherein the apparatus is further caused to:
in response to receiving an application package comprising the one or more files that are part of the application by way of a secure download from a source, cause a hash calculator to calculate a hash for the application package;
generate the application manifest file, wherein the hash included in the application manifest file is the hash for the application package; and
cause the application manifest file to be stored in the secure storage.

5. The apparatus of claim 4, wherein the application manifest file is generated before the firmware is executed.

6. The apparatus of claim 4, wherein the application manifest file is generated after the firmware is executed and before the trust agent is executed.

7. The apparatus of claim 1, wherein the apparatus is further caused to:
during a secure download of the one or more files that are part of the application by way of a secure download from a source, cause a hash calculator to calculate a hash for an application package comprising the one or more files that are part of the application;
generate the application manifest file, wherein the hash included in the application manifest file is the hash for the application package; and
cause the application manifest file to be stored in the secure storage.

8. A method, comprising:
causing firmware executed by a processor to verify a bootloader;
in response to verifying the bootloader, causing the bootloader to be executed to verify a kernel;
in response to verifying the kernel, causing the kernel to be executed to verify a trust agent;
in response to verifying the trust agent, causing the trust agent to process an application list to identify one or more files that are part of an application and to generate a hash for all of the one or more files combined or for each of the one or more files individually;
comparing the hash for all of the one or more files combined or for each of the one or more files individually with a hash included in an application manifest file stored in a secure storage; and
in response to confirming a hash match between the hash for all of the one or more files combined or for each of the one or more files individually and the hash included in the application manifest file, causing the one or more files that are part of the application to be executed.

9. The method of claim 8, wherein the trust agent is a kernel module.

10. The method of claim 8, wherein
the bootloader comprises a shim and a grub,
the firmware verifies the shim to verify the bootloader and causes the shim to be executed to verify the grub, and
in response to verifying the grub, the grub verifies the kernel such that the bootloader verifies the kernel.

11. The method of claim 8, further comprising:
in response to receiving an application package comprising the one or more files that are part of the application by way of a secure download from a source, causing a hash calculator to calculate a hash for the application package;
generating the application manifest file, wherein the hash included in the application manifest file is the hash for the application package; and
causing the application manifest file to be stored in the secure storage.

12. The method of claim 11, wherein the application manifest file is generated before the firmware is executed.

13. The method of claim 11, wherein the application manifest file is generated after the firmware is executed and before the trust agent is executed.

14. The method of claim 8, further comprising:
during a secure download of the one or more files that are part of the application by way of a secure download from a source, causing a hash calculator to calculate a hash for an application package comprising the one or more files that are part of the application;
generating the application manifest file, wherein the hash included in the application manifest file is the hash for the application package; and
causing the application manifest file to be stored in the secure storage.

15. A non-transitory computer readable medium having instructions stored thereon that, when executed by a processor, cause an apparatus to:
cause firmware executed by a processor to verify a bootloader;
in response to verifying the bootloader, cause the bootloader to be executed to verify a kernel;
in response to verifying the kernel, cause the kernel to be executed to verify a trust agent;
in response to verifying the trust agent, cause the trust agent to process an application list to identify one or more files that are part of an application and to generate a hash for all of the one or more files combined or for each of the one or more files individually;
compare the hash for all of the one or more files combined or for each of the one or more files individually with a hash included in an application manifest file stored in a secure storage; and
in response to confirming a hash match between the hash for all of the one or more files combined or for each of the one or more files individually and the hash included in the application manifest file, cause the one or more files that are part of the application to be executed.

16. The non-transitory computer readable medium of claim 15, wherein the trust agent is a kernel module.

17. The non-transitory computer readable medium of claim 15, wherein
the bootloader comprises a shim and a grub,
the firmware verifies the shim to verify the bootloader and causes the shim to be executed to verify the grub, and
in response to verifying the grub, the grub verifies the kernel such that the bootloader verifies the kernel.

18. The non-transitory computer readable medium of claim 15, wherein the apparatus is further caused to:
in response to receiving an application package comprising the one or more files that are part of the application by way of a secure download from a source, cause a hash calculator to calculate a hash for the application package;
generate the application manifest file, wherein the hash included in the application manifest file is the hash for the application package; and
cause the application manifest file to be stored in the secure storage.

19. The non-transitory computer readable medium of claim 18, wherein the application manifest file is generated before the firmware is executed.

20. The non-transitory computer readable medium of claim 15, wherein the apparatus is further caused to:
during a secure download of the one or more files that are part of the application by way of a secure download from a source, cause a hash calculator to calculate a hash for an application package comprising the one or more files that are part of the application;
generate the application manifest file, wherein the hash included in the application manifest file is the hash for the application package; and
cause the application manifest file to be stored in the secure storage.
